(19) United States
(12) Patent Application Publication
(10) Pub. No.: US 2026/0295509 A1
(43) Pub. Date: Oct. 1, 2026

(54) Method Of Abating Carbon Dioxide And Hydrogen Sulfide

(71) Applicants: Carbfix, Reykjavik (IS); University of Iceland, Reykjavik (IS); The Trustees of Columbia University In The City Of New York, New York, NY (US); Barnard College, New York, NY (US)

(72) Inventors: Bergur SIGFÚSSON, Reykjavik (IS); Edda Sif Pind ARADÓTTIR, Reykjavik (IS); Ingvi GUNNARSSON, Reykjavik (IS); Magnús Þór ARNARSON, Reykjavik (IS); Einar GUNNLAUGSSON, Reykjavik (IS); Hólmfriður SIGURDARDÓTTIR, Reykjavik (IS); Húni SIGHVATSSON, Reykjavik (IS); Sigurður Reynir GÍSLASON, Reykjavik (IS); Eric H. OELKERS, Toulouse (FR); Kiflom G. MESFIN, Reykjanesbrer (IS); Sandra Osk SNAEBJÖRNSDÓTTIR, Reykjavik (IS); Iwona M. GALECZKA, Kopavogur (IS); Domenik WOLFF-BOENISCH, Coolbellup (AU); Helgi A. ALFREDSSON, Myvatni (IS); Porsteinn JÓNSSON, Reykjavik (IS); Andri STEFÁNSSON, Reykjavik (IS); Jürg MATTER, Winchester (GB); Martin STUTE, New York, NY (US); Deirdre Elizabeth CLARK, Reykjavik (IS); Martin Johannes VOIGT, Sturlugata 7 (IS)

(21) Appl. No.: 19/202,395

(22) Filed: May 8, 2025

Related U.S. Application Data
(63) Continuation of application No. 18/772,960, filed on Jul. 15, 2024.
Application No. 18/772,960 is a continuation of application No. 17/595,572, filed on May 22, 2020, now Pat. No. 12,121,850.

(30) Foreign Application Priority Data
May 22, 2019 (EP) 19175986

(51) Int. Cl. B01D 53/14; B65G 5/00; E21B 41/00; E21B 47/11

(52) U.S. Cl. CPC B01D 53/1475; B01D 53/1412; B01D 53/1468; B65G 5/00; E21B 41/0064; E21B 47/11; B01D 2252/103; Y02C 20/40

(57) ABSTRACT

A method and a system of abating carbon dioxide (CO₂) and/or hydrogen sulfide (H₂S) in a geological reservoir. Water is pumped or transferred from a water source to an injection well. The gasses are merged with the water under conditions where the hydraulic pressure of the water is less than the pressure of CO₂ and/or H₂S gas at the merging point. The water with CO₂ and/or H₂S gas bubbles is transferred further downwardly at a certain velocity higher than the upward flow velocity of said CO₂ and/or H₂S gas bubbles ensuring downward movement of gas bubbles resulting in full dissolution of said CO₂ and/or H₂S in the water due to elevating pressure.

### CROSS-REFERENCE TO RELATED APPLICATIONS

The present application is a continuation of U.S. Ser. No. 18/772,960, filed Jul. 15, 2024, which is a continuation of U.S. Ser. No. 17/595,572, filed Nov. 19, 2021, which is a National Stage (371) of PCT/EP2020/064306, filed May 22, 2020, which claims priority to EP 19175986.9, filed May 22, 2019, the entire contents of which is incorporated herein by reference.

### STATEMENT OF US GOVERNMENT SUPPORT

This invention was made with government support under DE-FE0004847 awarded by the United States Department of Energy. The government has certain rights in the invention.

### FIELD OF THE INVENTION

The present invention relates to a method and a system for abating carbon dioxide (CO2) and/or hydrogen sulfide (H2S) by injecting these into and subsequently storing these in a geological reservoir.

### BACKGROUND OF THE INVENTION

Carbon dioxide (CO2) and hydrogen sulfide (H2S) are two gasses often released in large quantities during a wide range of industrial processes, e.g. combustion of fossil fuels. Both gasses present important challenges to the environment.

The reduction of industrial CO2 emissions is one of the main challenges of this century (Ref 1: Broecker and Kunzig). In general, CO2 emission is relatively low from geothermal resources and these are classified as renewable energy sources. This is in contrast to regular power plants that are run on fossil fuels which buy and sell pollution permits (called “allowances”).

Conventional geothermal plants utilize the heat of the Earth by making use of a hot mixture of steam and brine from a geothermal reservoir, characterized by a thermal anomaly, permeable rock, and fluid (Ref 2: Barbier). The geothermal steam from these geothermal
reservoirs naturally contains dissolved gases including both the greenhouse gas CO2 and hydrogen sulfide (H2S). The gases are a by-product of the geothermal energy production and are of magmatic origin. When conventional geothermal plants are operated the gases in the steam are vented into the atmosphere.

Hitherto geothermal power plants have been exempted from buying CO2 allowances as their greenhouse gas emission is fairly low. However, as climate change policy becomes stricter this might change and it is predicted that the price of emitting CO2 will rise.

The emission of hydrogen sulfide from geothermal power plants is another of the main environmental concerns of geothermal utilization. Hydrogen sulfide is a colorless, flammable and toxic gas with the characteristic odor of rotten eggs. Exposure to it can cause health problems depending on levels and duration of exposure. Low level, prolonged exposure can cause inflammation and irritation of the eyes whereas high levels of exposure for brief periods of time can cause dizziness, headache, nausea and even death if the concentration of H2S in atmosphere goes above 300 ppm.

Concentration of hydrogen sulfide in geothermal fluids is usually in the range of few ppb to several hundred ppm (Ref 3+4: Arndórson). During utilization of high temperature geothermal fluids, the hydrogen sulfide is concentrated in the steam phase and subsequently released into atmosphere after the steam condenses. Annually e.g. the Hellisheidi power plant, which is in Iceland, emits 9500 tons of hydrogen sulfide into atmosphere without any abatement system in place. The hydrogen sulfide is released on top of the cooling towers to lower the risk of high concentration of hydrogen sulfide close to the power station. The hydrogen sulfide is carried by wind away from the site of the power plant and can under some weather conditions cause foul smell in nearby communities.

To date CO2 has been stored e.g. as a supercritical fluid in association with major gas and oil production facilities such as Sleipner in the North Sea, In Salah, Algeria, and Weybum, Canada (Ref 5: Kerr). Regardless, the abatement of CO2 in geological structures remains an attractive, although still relatively unexplored, possibility for reducing the amount of CO2 emitted to the atmosphere whether originating from geothermal energy production or from other sources (such as e.g. conventional power plants). The standard approach to geologic carbon storage/sequestration is to inject CO2 as a bulk phase into geologic formations at depth >800 m. At this depth CO2 is supercritical and buoyant with respect to the host rock fluids. As a result, buoyant CO2 may migrate back to the shallow subsurface and surface (Ref 6: Hawkins; Ref 7: Benson).

Gislason et al. (Ref 8) describes in a general way a method of capturing CO2 that is transported in a 3 km pipeline to the pilot injection site as high pressurized gas. In the method envisaged, CO2 is to be injected together with co-injected water, which will divert the injected CO2 further down the well, which is according to the authors of the publication results in a single fluid phase entering the sequestration formation. Similarly Sigfusson et al. (Ref. 16) describes the injection of app. 175 t of CO2 dissolved in 5000 t of water (at a depth of app 350 m below surface) into porous rocks located 400-800 m below the surface, and points to the fact that, even if large volumes of water are required for CO2 storage via this method, the storage can be done at a lower distance from the surface than in case of supercritical CO2, because the CO2 is dissolved and, hence, no longer buoyant. Likewise Gunnarson et al. (Ref 17) describes the continuous injection of CO2 and H2S (dissolved in water at a depth of app 750 m below surface) into basaltic rock located about 2000 m below surface at temperatures ranging from 200 to 260 C, and points to the fact that the large depth and high temperature permits injection of larger quantities of CO2 and H2S than what can be obtained with injection into more shallow and colder rock formations.

The methods described in detail in these publications differ from those of the present invention. Thus, neither of these publications points to the importance of the relationship between the downward velocity of the water flow and the capability to efficiently ensure that the CO2 and/or H2S, released as bubbles of a given dimension at the merging point, are kept in solution at a given depth/pressure. The publications are, thus, silent as to the importance of transferring the water, which has been merged with the CO2 and/or H2S rich gas streams, downwardly at a velocity, which is higher than the upward velocity of the bubbles of CO2 and/or H2S gas dissolved in the water. In fact, quite to the contrary (Ref 16) simply more generally points to the importance of dissolving the carbon-dioxide into the water during its injection, and mentions only typical volumetric flow rates and average residence times, just like it focuses on the importance of a fixed water to CO2 mass ratio. This implies that it was apparently not fully understood by the authors of these publications at that point in time exactly which factors may in fact affect the usefulness of such methods. Similarly, neither of these publications points to the associated finding of the present invention that the water demand can thereby be diminished simply by increasing the downward flowing velocity of the water, e.g. by reducing the diameter of the pipe surrounding the merging point of the gas and water. This feature is of great economical importance to the feasibility of the methods of the present invention compared to those described in the prior art.

A review of the processes available for H2S abatement in the context of e.g. geothermal energy production (i.e. geothermal power plants) is provided by Sanopoulos and Karabelas (Ref 9). Most known methods involve oxidation of H2S to elemental sulfur or sulfuric acid. The value of these products is low as there is either too little demand or excess supply. Disposal of these products is costly and can create environmental problems.

It has been speculated by Hibara et al. (Ref 10) that H2S may be compressed and mixed with brine and reinjected into an auxiliary well. However, until now neither has such a method of abating hydrogen sulfide been described in detail, nor is it fully understood which factors may in fact affect the usefulness of such a method.

From the above it may be appreciated that there is a need for new, cost-effective and environmentally friendly abatement methods for abating CO2 and/or H2S, whether originating from geothermal energy production or from other sources (such as e.g. conventional power plants). The inventors of the present invention have found a new method to facilitate the safe and permanent geologic storage/sequestration of both CO2 and H2S which enables that the water demand can be diminished considerably by increasing the downward flow velocity of the water, e.g. by simply reducing the diameter of the pipe surrounding a merging point of the CO2 and/or H2S rich gas stream and the water. Thus, the safe long-term storage of CO2 and/or H2S can be facilitated simply by controlling how much CO2 and/or H2S gas is to be dissolved in the injected water at the given merging point and at a given downward velocity of the water.

### SUMMARY OF THE INVENTION

As noted above, it would be advantageous to achieve an effective and environmentally friendly method for abating carbon dioxide emissions and/or hydrogen sulfide both of which are emitted from power plants, conventional as well as geothermal. In general, the present invention preferably seeks to mitigate, alleviate or eliminate one or more of the above mentioned disadvantages singly or in any combination.

To better address one or more of these concerns, in a first aspect of the invention a method is provided for storing carbon dioxide (CO2) and/or hydrogen sulfide (H2S) in a geological reservoir, comprising:
pumping (or otherwise transferring) water from a water source to an injection well,
dissolving CO2 and/or H2S gas in the water by merging a CO2 and/or H2S rich gas stream with the water under conditions where the hydraulic pressure of the water is lower than the partial pressure of the CO2 and/or H2S in the CO2 and/or H2S rich gas stream,
ensuring that the dissolved CO2 and/or ¾S is kept in solution in the water by transferring the water comprising the dissolved CO2 and/or H2S downwardly at a velocity, which is higher than the upward velocity of the bubbles of CO2 and/or H2S gas in the water,
keeping the resulting pH value of said pressurized water stream containing said dissolved CO2 and/or H2S between about 2 and 4, preferably between about 2.5 and 3.5, more preferably about 3.2, and
injecting the water comprising the dissolved CO2 and/or H2S into the geological reservoir.

In the context of the present invention the term pumping is to be understood as any means of transferring a liquid, e.g. water, from one location to another.

In the context of the present invention, the term water source or water is to be understood as any kind of water, such as e.g. groundwater, ocean/sea-water, spring water, geothermal condensate or brine, or surface waters from rivers, streams or lakes.

In the context of the present invention the term injection well is to be understood as any kind of structure providing for a possibility of placing fluids or gases either deep underground or just into the ground in a downwardly direction, such as e.g. a device that places fluid into reactive rock formations, such as basalt or basaltic rock, and porous rock formations, such as sandstone or limestone, or into or below the shallow soil layer.

In the context of the present invention, a CO2 and/or H2S rich gas stream is to be understood as any gas stream of which the relative content of CO2 and/or H2S is higher than the relative content of CO2 and/or H2S of atmospheric air.

In the context of the present invention the term hydraulic pressure is to be understood as the pressure of a hydraulic fluid, which it exerts in all direction of a vessel, well, hose or anything in which it is present. A hydraulic pressure may give rise to flow in a hydraulic system as fluid flows from high pressure to low pressure. Pressure is measured in the SI unit pascal (Pa), i.e. one newton per square meter (1 N/m²) or 1 kg/(m s²), or 1 J/m³. Other units of pressure commonly used are pound per square inch or, more accurately, pound-force per square inch (abbreviation: psi) and bar. In SI units, 1 psi is approximately equal to 6895 Pa and 1 bar is equal to 100,000 Pa.

In the context of the present invention, the term partial pressure or just pressure of a gas (of the CO2 and/or H2S) is to be understood as the notional pressure of said given gas in a mixture of gases, if this given gas in itself occupied the entire volume of the original mixture at the same temperature. The total pressure of an ideal gas mixture is the sum of the partial pressures of the individual constituent gases in the mixture.

In the context of the present invention, the term velocity is to be understood as a vector quantity that refers to the rate at which an object changes its position in a certain direction. Thus, velocity equals distance/time and the SI unit is m/s. Water moving in a given direction at a given velocity will do so with a certain flow rate, which may be provided as either a volumetric flow rate or a mass flow rate. Volumetric flow rate is the volume of fluid, which passes a given point per unit time and is usually represented by the symbol Q (sometimes V). The SI unit for volumetric flow rate is m3/s. Thus, volume flow rate equals volume/time. Mass flow rate on the other hand is the mass of fluid, which passes a given point per unit time (kg/s).

In the context of the present invention injecting or inject is to be understood as introducing something forcefully into something else, i.e. to force a fluid into an underground structure.

In the context of the present invention, the term geological reservoir is to be understood as fractures in an underground structure, e.g. basaltic rock, that expands in other directions than upwardly and downwardly, which structure provides a flow path for the water injected into an injection well according to the present invention and may include what is referred to as a geothermal reservoir. In the present context the term geothermal reservoir is to be understood as fractures in hot rock that expand in other directions than upwardly and downwardly and provide a flowing path for the injected water from a well.

The fact that the method and the systems of the present invention ensures that the pressure of the dissolved CO2 and/or H2S is less than the hydraulic pressure of the water (and is thereby kept in solution) when transferring the water downwardly, ensures that the CO2 and/or H2S stays dissolved in the water, which improves considerably security due to decreased leakage risks. Also, this enables that the water demand of methods according to the present invention can be diminished considerably by increasing the downward flow velocity of the water, e.g. by simply reducing the diameter of the pipe surrounding a merging point of the CO2 and/or H2S rich gas stream and the water. Injection of CO2 promotes the carbonation of the host rock and thus facilitates the safe long-term storage of CO2 in the subsurface. Accordingly, a method is provided where water-rock reactions already taking place in natural reactive rock, e.g. basaltic rock, reservoirs in geothermal systems are utilized by means of injecting CO2 and/or H2S back into the reservoir geothermal system. The environmental impact caused by CO2 and/or H2S gas emission from e.g. geothermal plants will therefore be lowered. Also, the safe long-term storage of CO2 and/or H2S can be facilitated simply by controlling how much CO2 and/or H2S gas is to be dissolved in the injected water at the given merging point and at the given downward velocity of the water.

Also, the abatement method of the present invention is very economical and environmentally friendly as there are no byproducts that need to be disposed of. Returning the CO2 and/or H2S back to where they came from has to be considered as an ideal method for reducing gas emission from e.g. geothermal power plants.

The fact that the method and the systems of the present invention ensures that the gas pressure (i.e. the partial pressure) of the dissolved CO2 and/or H2S is less than the hydraulic pressure of the water (and is thereby kept in solution) when transferring the water downwardly, ensures that the gasses stays dissolved in the water and do not degas from the water. Thus, the method of the present invention minimizes the risk of gas bubbles rising out of the water, which would otherwise mean that the CO2 and/or H2S would not be effectively transferred into the geological reservoir where the gasses are to absorbed and/or mineralized.

At the same time the low pH of the water promotes the dissolution of minerals in the geological reservoir thereby providing the cations necessary for carbon and sulphur mineralization and abatement.

Since the pressure of the CO2 and/or H2S prior to injecting them into the water is larger than the hydraulic pressure of the water, gas bubbles will be present in the water at the merging point (i.e. the point of gas injection), but since the gas bubbles are transferred downwardly at a critical water velocity, it is ensured that the gas streams will dissolve into the water and stay dissolved, i.e. will stay in solution.

In one embodiment, said step of dissolving the gas in the water comprises conducting the CO2 and/or H2S gas via an injection pipe having an open end extending down into said injection well at a depth that is selected such that the hydraulic pressure of the water in said injection well at said open end of the injection pipe is less than the CO2 and/or H2S gas pressure in the injection pipe, while at the same time ensuring that the water is transferred downwardly at a velocity relative to the point where the gasses are injected into the injection well, which ensures that for a given subpart of the water stream the hydraulic pressure of the water is larger than the pressure of the dissolved CO2 and/or H2S relatively shortly after the gasses have been injected into the water. Thus, the hydraulic pressure that is needed both to dissolve the CO2 and/or H2S gas in the water and to keep the CO2 and/or H2S gas in solution in the water is obtained by transferring the water and the gases to the appropriate depth(s) and therefore no external energy is needed at neither the merging point nor below to obtain or keep the hydraulic pressure needed.

Furthermore, a method according to the present invention ensures that when the CO2 and/or H2S is injected into the injection well (which is possible because the hydraulic pressure in the injection pipe is larger than the hydraulic pressure in the injection well) at the open end it will not start to “effervesce” after being injected, but instead be kept in a dissolved state, i.e. in solution, for the necessary time frame for the CO2 and/or H2S mineralizing water rock reactions to take place. This is similar to avoiding the scenario that would otherwise occur when a bottle of soda is opened, and the bubbling of carbon dioxide starts and thus the releasing of the carbon dioxide from the bottle into the atmosphere. Thus, if the bottle is opened under a surrounding pressure equal to or higher than that in the bottle such a carbon dioxide bubbling would not occur. The low pH of the water, in a method according to a method according to the present invention, furthermore, due to the presence of dissolved CO2 and/or H2S therein promotes the dissolution of minerals in the geological reservoir thereby providing the cations necessary for carbon and sulphur mineralization and abatement.

In one embodiment, the step of dissolving CO2 and/or H2S gas in the water comprises conducting the CO2 and/or H2S gas via an injection pipe having an open end extending down into said injection well where the injection pipe is surrounded by an outer pipe having an open end positioned at a larger depth than said open end of the injection pipe, said pumping of water being performed into the space between the outer pipe and the injection pipe, said depth at the open of the injection pipe within said outer pipe being selected such that the hydraulic pressure of the water within the outer pipe at said open end of the injection pipe is less than the CO2 and/or H2S gas pressure in the injection pipe, while at the same time ensuring that the water is transferred downwardly at a velocity relative to the point where the gasses are injected into the injection well, which ensures that for a given subpart of the water stream the hydraulic pressure of the water is larger than the sum of the partial pressure of the dissolved CO2 and/or H2S relatively shortly after the gasses have been injected into the water.

In one embodiment, the pumping rate of the water and the diameter of the pipe is selected such that the drag force of the downward flowing water into the injection well is larger than the buoyant force on the CO2 and/or H2S. It is thus ensured that a constant downwardly flowing water stream is provided ensuring that the dissolved CO2 and/or H2S will move downward and towards the storage reservoir. Methods or systems working with relatively small bubbles, e.g. below 6 mm in diameter, will according to the present invention need a minimum water velocity of between 0.4 m/s and 1.4 m/s depending on dynamic forces in the system.

In one embodiment, the pressure of the CO2 gas at the open end of the injection pipe (i.e. where the hydraulic pressure of the water in said injection well is less than the CO2 gas pressure in the injection pipe) is between 20-35bar. At this pressure, the temperature of the water may be, but is not limited to, between 20-40° C. resulting in a single fluid phase entering the storage formation, which e.g. consists of relatively fresh basaltic lavas.

In one embodiment, the depth at said open end of the outer pipe is selected such that pH value of the injection water containing dissolved CO2 is between 2 and 4, preferably between 2.5 and 3.5, more preferably around 3.2. It is at this depth that the dissolved CO2 and/or H2S leave the outer pipe and the sequestration of the CO2 and H2S in rocks starts, i.e. the storing of the carbon dioxide CO2 and/or hydrogen sulphide H2S in the geological reservoir. The lower the pH value the faster will the dissolution rate be of the rock meaning that with such a low pH value the sequestration of the carbon dioxide CO2 and/or hydrogen sulphide H2S in the storage reservoir will be significantly enhanced.

In one embodiment, said step of dissolving the CO2 and/or H2S gas in said water further includes mixing, e.g. by means of a sparger and/or mixer, the dissolved CO2 and/or H2S with the water at or below the merging point so as to obtain a uniform mixing of the CO2 and/or H2S gas in the water, breaking up larger bubbles and dissolving any remaining CO2 and/or H2S gas bubbles in the water. Accordingly, more turbulence will be created in the mix of CO2 and/or H2S gas and the pressurized water, which will enhance the dissolution of CO2 and/or H2S gas at and/or below the merging point further. Also, large CO2 and/or H2S gas bubbles will be split into smaller gas bubbles which will also enhance the dissolution of the CO2 and/or H2S.

In one embodiment, said source of water is selected from one or more of the following: surface waters, groundwater or seawater.

In one embodiment, said step of dissolving the CO2 gas with said water further includes maximizing the interfacial area between the CO2 and/or H2S gas and the water. Accordingly, the CO2 and/or H2S gas bubbles will be equally distributed within the pressurized water and further the average diameter of the bubbles will be reduced causing said maximization of the interfacial area between the CO2 and/or H2S gas and the water, where both these factors enhance the dissolution rate of CO2 and/or H2S in the pressurized water significantly.

In one embodiment, said step of dissolving the CO2 and/or H2S gas in said water further includes mixing the dissolved CO2 and/or H2S with the water so as to obtain a uniform mixing of the CO2 and/or H2S gas in the water and dissolving any remaining CO2 and/or H2S gas bubbles in the water. Accordingly, more turbulence will be created in the mix of CO2 and/or H2S gas and the pressurized water, which will enhance the dissolution of CO2 and/or H2S gas further. Also, large CO2 and/or H2S gas bubbles will be split into smaller gas bubbles which will also enhance the dissolution rate of the CO2 and/or H2S.

In one embodiment, said step of dissolving CO2 and/or H2S gas in the water comprises conducting the CO2 and/or H2S gas via an injection pipe having an open end extending down into said injection well at a depth that is selected such that the hydraulic pressure of the water in said injection well at said open end of the injection pipe is less than the CO2 and/or H2S gas pressure in the injection pipe, while at the same time ensuring that the water is transferred downwardly at a velocity relative to the point where the gasses are injected into the injection well, which ensures that for a given subpart of the water stream the hydraulic pressure of the water is larger than the partial pressure of the dissolved CO2 and/or H2S relatively shortly after the gasses have been injected into the water. The hydraulic pressure is slightly less than the gas pressure at the depth of the merging point, firstly to ensure that the CO2 and/or H2S gas can enter the water in the injection well at the depth of the merging point and secondly, that, after having been dissolved in the water and moved downwardly at a given downwardly velocity, the hydraulic pressure of the water at that somewhat larger depth is larger than the pressure of the CO2 and/or H2S. Accordingly, by selecting the depth of the merging point in the injection well and the downwardly velocity of the water it is ensured that the CO2 and/or H2S gas bubbles coming from the open end of the injection pipe will within very short timeframe be dissolved in the water and the CO2 and/or H2S will stay dissolved in the water prior to the mineralization process within the geological reservoir. At the same time the low pH of the water, due to the addition of the CO2 and/or H2S gas promotes the dissolution of minerals in the geological reservoir thereby providing the cations necessary for carbon and sulphur mineralization and abatement.

In one embodiment, the method further comprises the step of estimating the mineralization capacity of the CO2 and/or H2S where the step of estimating this comprises:
dissolving, in addition to said CO2 and/or H2S, a tracer substance in the water, the concentration of the dissolved CO2 and/or H2S and the dissolved tracer substance being performed in a controllable way such that the initial molar ratio between CO2 and/or H2S and the tracer substance is pre-determined,
monitoring, in response to injecting said CO2 and/or H2S and the dissolved tracer substance, the molar ratio between the CO2 and/or H2S and the tracer substance in a monitoring well, the monitoring well being a well interlinked to said injection well via a flow path such that at least a part of said injected water mixed with said dissolved CO2 and/or H2S and said tracer substance flows to said monitoring well via said flow path, the monitoring including measuring the concentration of the CO2 and/or H2S and the tracer substance and based thereon the molar ratio between the CO2 and/or H2S and the tracer substance at said monitoring well, and
determining an abatement indicator indicating the amount of CO2 and/or H2S abatement achieved via water-rock reactions, said determination being based on comparing the molar ratio between the CO2 and/or H2S and the tracer substance in the monitoring well with the corresponding molar ratio in the injection well at the merging point.

Based on such a measurement it is possible to determine whether the geological reservoir in question possesses the ability to store in mineralogical form the CO2 and/or H2S, which is injected via the injection well.

As regards CO2 said tracer substance can be, but is not limited to, SF5CF3 tracer, SF6 or Rhodamine tracer (all being conservative tracers), or C-14 tracer to trace only the carbon. One or more of these tracers may be used at the same time.

Similarly, it is possible to determine whether geological systems in e.g. Iceland, possess the ability to mineralize H2S through water-rock reactions by use of tracer substance such as, but not limited to, iodine ions by dissolving KI in the pressurized water.

In one embodiment, the method further comprises carrying out a correction of said abatement indicator taking into account oxidation of H2S with other sulfide species. This will thus make the estimation of the abatement capacity more precise. Correction may be made by analyzing other types of sulfur in the geothermal water from the injection well, compare them to values obtained prior to injection of the H2S and adding the excess sulfur species (e.g. SO4²⁻ and S2O3⁻) formed by oxidation of H2S to the H2S value before calculating the H2S abatement index.

In one embodiment, the interlink between said injection well and monitoring well is a fracture in the geological reservoir.

In one embodiment, said method further comprises providing a constriction at the open end of said injection pipe so as to maintain high hydraulic pressure in the injection pipe so as to further secure that the CO2 or the H2S gas will remain dissolved in the injected water.

In a second aspect of the invention a system is provided adapted for abating CO2 and/or H2S, comprising:
means for pumping water from a water source into an injection well,
means for pumping CO2 and/or H2S gas into an injection well
means for dissolving the CO2 and/or H2S gas in the water at a depth, h1≥0, in the injection well where the hydraulic pressure of the water is lower than the pressure of the CO2 and/or H2S,
means for transferring said water stream from said depth h1≥0 to a greater depth h1+h2, where h1+h2>h1, at a downward flow velocity, which is higher than the upward flow velocity of the bubbles of said CO2 and/or H2S gas, resulting from the buoyant force on said bubbles of CO2 and/or H2S gas in said water,
means for keeping the resulting pH value of said pressurized water stream containing said dissolved CO2 and/or H2S between about 2 and 4, preferably between about 2.5 and 3.5, more preferably about 3.2, and
means for injecting the water comprising said dissolved CO2 and/or H2S into a geological reservoir.

In one embodiment, said means for dissolving CO2 and/or H2S gas in the water comprises an injection pipe for conducting high pressurized CO2 and/or H2S gas into the injection well, the injection pipe having an open end extending down into said injection well at a depth h1≥0 that is selected such that the hydraulic pressure of the water in said injection well at said open end of the injection pipe is less than the CO2 and/or H2S gas pressure in the injection pipe, and pump means enabling a downward flow velocity of the water higher than the upward flow velocity of bubbles of said CO2 and/or H2S gas at depths larger than hi, thereby ensuring that the water is transferred to depths larger than hi without the CO2 and/or H2S escaping the water.

In one embodiment, the system further comprises an outer pipe surrounding said injection pipe having an open end extending down into said injection well at a further depth h1+h2, said means for pumping being a water pump that pumps the water into the space between the outer pipe and the injection pipe, said means for injecting the dissolved CO2 and/or H2S into the geological reservoir being the downward flow velocity and resulting flow rate of water formed through the pumping of the water into said space between the outer pipe and the injection pipe. In a situation wherein the gas is restricted to CO2 the h1+h2 may be selected such that the pH value of the injection water containing dissolved CO2 is below a pre-defined pH limit.

In one embodiment, said means for dissolving CO2 and/or H2S with the water further comprises:
a sparger mounted at said open end of the gas injection pipe adapted to maximize the interfacial area between the CO2 and/or H2S gas and the water, or
a mixer mounted within said outer pipe between said open end of the injection pipe and said open end of the outer pipe adapted for mixing the CO2 and/or H2S with the water so as to obtain a uniform mixing of the CO2 and/or H2S gas in the water and dissolving any remaining bubbles of CO2 and/or H2S gas in the water, or
a sparger mounted at said open end of the injection pipe adapted to maximize the interfacial area between the CO2 and/or H2S gas and the water and a mixer mounted within said outer pipe between said sparger and said open end of the outer pipe adapted for mixing the CO2 and/or H2S with the water so as to obtain a uniform mixing of the CO2 and/or H2S gas in the water and dissolving any remaining bubbles of CO2 and/or H2S in the water.

Accordingly, a practical and cost-effective system for in situ mineral carbonation in reactive rocks, e.g. basaltic rocks, is provided that injects water with high enough concentrations of dissolved CO2 and/or H2S concentration to favor reaction with the reactive rock, e.g. basaltic rock. Similarly, the low pH of the water promotes the dissolution of minerals in the geological reservoir thereby providing the cations necessary for carbon and sulphur mineralization and abatement.

In a method according to the present invention, once dissolved, CO2 and/or H2S is no longer buoyant, which dramatically improves security due to decreased leakage risks. Injection of dissolved CO2 and/or H2S also promotes the carbonation of the host rock and thus facilitates the safe long-term storage of CO2 and/or H2S in the subsurface.

It should be noted that the term water can according to the present invention mean fresh water, water from geothermal wells, brine, sea water and the like. Said water source may, thus, be any type of water. Likewise, the CO2 and/or H2S gas may originate from any source, such as conventional power plants, geothermal power plants, industrial production, gas separation stations or the like.

In general, the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Hereinafter a number of embodiments of the invention are described, by way of example only, with reference to the drawings, in which

FIG. 1 shows a flowchart of a method according to the present invention of abating CO2 and/or H2S in a geological reservoir.

FIG. 2 shows a schematic representation of host rock and formation fluid interaction during in situ CO2 mineral sequestration.

FIG. 3 shows a flowchart of an embodiment of a method according to the present invention indicating in more details how the dissolved CO2 and/or H2S is injected into the geological reservoir.

FIG. 4 shows a system according to the present invention for storing carbon dioxide (CO2) in a geological reservoir.

FIG. 5 shows a flowchart of an embodiment of a method according to the present invention of abating hydrogen sulfide (H2S) in a geological reservoir.

FIG. 6A depicts schematically a method in FIG. 5 showing an injection well where water is continuously being pumped into the well.

FIG. 6B shows the water-rock reactions that occur in the geothermal reservoir in a flow path of the dissolved H2S in the rock.

FIG. 7 shows the relation between the downward flow velocity (m/s) of water into an injection well and the diameter of spherical (upper line) and elongated (lower line) gas bubbles where the buoyancy and downward drag force are in a balance at a given temperature, pressure and gas and water compositions. The shaded area represents bubbles with a form between spherical and elongated. As is clear from this figure, means capable of creating small bubbles will result in a method or system according to the present invention (i.e. being at least in balance) being capable of operation at relatively low flow velocities, e.g. below 0.4 m/s, whereas means limited to larger bubbles will necessitate a means capable of providing higher flow velocities, e.g. above 0.8 m/s, in order to be able to provide a method or system according to the present invention (i.e. being in balance).

FIG. 8 shows an expanded view of the first quarter of FIG. 7.

FIGS. 9-11 depicts graphically different embodiments of a system according to the present invention for abating hydrogen sulfide (H2S) and carbon dioxide (CO2), in a geological reservoir.

### DESCRIPTION OF EMBODIMENTS

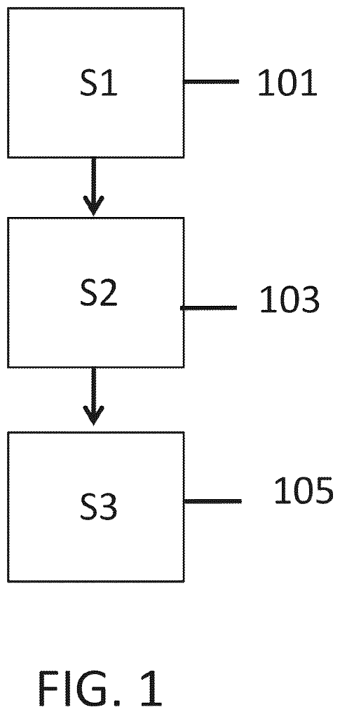

FIG. 1 shows a flowchart of a method according to the present invention of abating CO2 and/or H2S in a geological reservoir. The term geological reservoir may be understood as fractures in hot rock that expand in other directions than upwardly and downwardly and provide a flowing path for the injected water from the well.

In a first step (S1) 101, water is pumped from water source to an injection well. The water source may be, but is not limited to, geothermal water, brine and the like, or it can be fresh water and sea water. For simplicity, hereafter the term “water” will be used. Also, the temperature of the water can vary from being only a few degrees Celsius up to several hundred degrees.

In a second step (S2) 103, CO2 and/or H2S gas is merged with the water at a merging point where the hydraulic pressure of the water is lower than the pressure of CO2 and/or H2S, while at the same time ensuring that the water is transferred downwardly at a velocity relative to the point where the gasses are injected into the injection well, which ensures that for a given subpart of the water stream the hydraulic pressure of the water is larger than the partial pressure of the CO2 and/or H2S relatively shortly after the gasses have been injected into the water.

In step (S3) 105, the water with the dissolved CO2 and/or H2S is injected into the geological reservoir.

In one embodiment, step (S2) 103 comprises conducting the CO2 and/or H2S gas via an injection pipe having an open end extending down into said injection well at a depth, h1≥0, that is selected such that the hydraulic pressure of the water in the injection well at the open end of the injection pipe is less than the CO2 and/or H2S gas pressure in the injection pipe. This is simply to enable the CO2 and/or H2S gas to flow into the water at the depth h1≥0. At the same time a downward flow velocity of the water higher than the upward flow velocity of the bubbles of said CO2 and/or H2S gas at depths larger than hi is provided, thereby ensuring that the water is transferred to depths larger than hi without the CO2 and/or H2S escaping the water.

In a preferred embodiment the pressure of the CO2 gas at the open end of the injection pipe is between 20-35bar. This large pressure ensures that the pH value of water containing the dissolved CO2 is relatively low which will enhance the CO2 water rock reactions in the geological reservoir.

One of the important aspects of the present invention is the dissolution of CO2 (and/or H2S) in water before it is dispersed as a single-phase fluid into the pore space of reactive rock formations. The CO2 dissolves to form carbonic acid (H2CO3), which can dissociate into bicarbonate (HCO3) and carbonate (CO3²⁻) according to:

$${CO}_{2 ( g )} = {CO}_{2 ( a q )} \qquad ( 1 a )$$

$${CO}_{2 ( a q )} + {H}_{2} O = {H}_{2} {CO}_{3 ( a q )} \qquad ( 1 b )$$

$${H}_{2} {CO}_{3 ( a q )} = {HCO}_{3}^{-} + {H}^{+} \qquad ( 1 c )$$

$${HCO}_{3}^{-} = {CO}_{3}^{2 -} + {H}^{+} \qquad ( 1 d )$$

For example, plagioclase ((Ca, Na)A1_{1.70}Si_{2.30}O₈), olivine ((Mg, Fe)₂SiO₄) and pyroxene, ((Ca, Mg, Fe)₂SiO₃) are the most abundant primary minerals in basaltic rocks but basaltic glasses are also common. When the minerals and glasses come in contact with the injected acidic fluid, dissolution reactions occur leaching cations such as Ca²⁺, Mg²⁺ and Fe²⁺ from the rock matrix. Reactions 2-5 here below show the dissolution of plagioclase, olivine, pyroxene, and basaltic glass, respectively. Composition of basaltic glass in reaction 5 is that of Stapafell glass as reported in the scientific literature by Oelkers and Gislason (Ref 11).

$$( Ca , Na ) {Al}_{1.70} {Si}_{2.3} {O}_{8 ( s )} + 6.8 {H}^{+} = ( {Ca}^{2 +} , {Na}^{+} ) + 1.7 {Al}^{3 +} + 2.3 {SiO}_{2 ( a q )} + 3.4 {H}_{2} {O}_{( 1 )} \qquad ( 2 )$$

$${( Mg , Fe )}_{2} {SiO}_{4 ( s )} + 4 {H}^{+} = 2 {( Mg , Fe )}^{2 +} + {SiO}_{2 ( a q )} + 2 {H}_{2} {O}_{( 1 )} \qquad ( 3 )$$

$${( Ca , Mg , Fe )}_{2} {SiO}_{3} + 2 {H}^{+} = 2 {( Ca , Mg , Fe )}^{2 +} + {SiO}_{2 ( a q )} + {H}_{2} {O}_{( 1 )} \qquad ( 4 )$$

$${SiAl}_{0.36} {Fe}_{0.19} {Mg}_{0.28} {Ca}_{0.26} {Na}_{0.08} {K}_{0.008} {O}_{3.31} + 2.58 {H}^{+} = {Si O}_{2 ( a q )} + 0.36 {Al}^{3} + 0.19 {Fe}^{2 +} + 0.28 {Mg}^{2 +} + 0.26 {Ca}^{2 +} + 0.08 {Na}^{2 +} + 0.008 {K}^{2} + 1.3 {H}_{2} {O}_{( 1 )} \qquad ( 5 )$$

As dissolution reactions 2-5 proceed in the subsurface after CO2 and/or H2S injection, protons (H⁺) are consumed and pH of formation fluids increases.

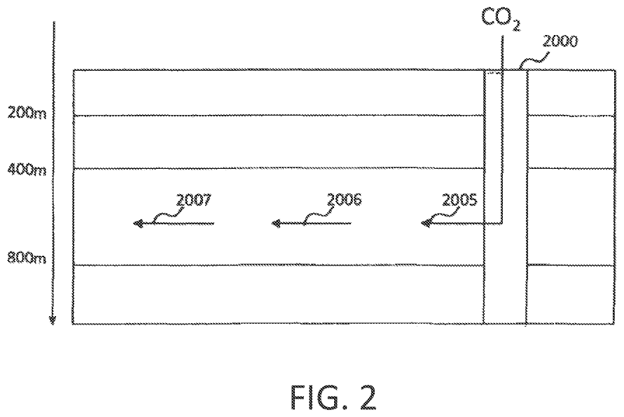

Concentration of leached cations also builds up as the water flows away from the injection well, as displayed in FIG. 2, showing a schematic representation of host rock and formation fluid interaction during in situ CO2 mineral sequestration after CO2 is injected into an injection well 2000. The left side in FIG. 2 shows a depth scale extending below 800 m. The arrows 2005-2007 indicate the direction of regional groundwater flow and also different distances from the injection well 2000, where at arrow 2005 the water next to the injection well 2000 may be weakly acidic, where a single phase fluid enters formations and leaches cations out of the rock matrix. At more distance from the injection well 2000, at arrow 2006 the concentration of the ions increases as dissolution of rock proceeds and the pH of water increases. At further distance from the injection well 2000, at arrow 2007 mineral supersaturation and precipitation occurs where clays and zeolites compete with carbonates for dissolved cations.

At certain concentrations, the water becomes supersaturated with respect to secondary minerals like carbonates, which begin to precipitate according to reaction 6:

$${( Ca , Mg , Fe )}^{2} + {CO}_{3}^{2} = ( Ca , Mg , Fe ) {CO}_{3 ( s )} \qquad ( 6 )$$

Calcite (CaCO3), dolomite (CaMg(CO3)2), magnesite (MgCO3) and siderite (FeCO3) are among proposed carbonate forming minerals. It is difficult to predict beforehand which of these carbonates will actually precipitate in the subsurface during CO2 injection as well as to what extent they will form. Other minerals, such as clays, hydroxides and zeolites, are likely to form as well and compete with reaction 6 for leached cations.

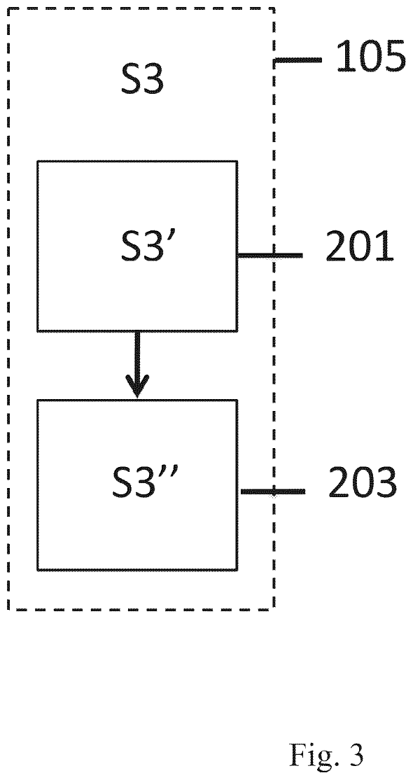

FIG. 3 shows a flowchart of an embodiment of a method according to the present invention indicating in more details how said step (S3) 105 is performed.

In step (S3′) 201, the hydraulic pressure of the water pumped from said water source is increased so as to form pressurized water. This may e.g. be done by pumping the water from the water source to the injection well via a pipeline, where the pressure in the pipeline is increased e.g. via the appropriate equipment such as a water pump such that the pressure can be controlled and adjusted to the pressure of the CO2 and/or H2S gas to be dissolved.

In step (S3″) 203, the CO2 and/or H2S gas is dissolved with the pressurized water, where the hydraulic pressure of the water is selected such that during the gas dissolution the hydraulic pressure of the water is less than the pressure of the CO2 and/or H2S gas. The pressure of the water is in one embodiment around 6 bars or somewhat lower than the pressure of the

CO2 and/or H2S gas. In this embodiment, said step (S3) 105 of injecting the dissolved H2S into the geological reservoir is performed via an injection pipe having an open end extending down into the injection well at a depth, h1≥0, that is below the surface level of the water in the injection well. This depth is preferably selected such that the hydraulic pressure of the water in the injection well where the open end of the injection pipe is located in the well is less than the hydraulic pressure of the water in the injection pipe, but at a somewhat larger depth, h2, reached when the water flows downward, is larger than the pressure of the dissolved CO2 and/or H2S. The reason of doing so is to ensure that when the water with the dissolved CO2 and/or H2S comes out from the open end of the injection pipe, the surrounding pressure will be larger than the pressure of the dissolved CO2 and/or H2S. By doing so the dissolved CO2 and/or H2S will stay in a dissolved state until the CO2 and/or H2S mineralizing water rock reactions start. At the same time the low pH of the water containing the dissolved CO2 and/or H2S promotes the dissolution of minerals in the geological reservoir thereby providing the cations necessary for carbon and sulphur mineralization and abatement. This gas dissolving process can be facilitated by using the appropriate equipment for maximizing the interfacial area between the H2S gas and the water and/or mixing the dissolved H2S with the water so as to obtain a uniform mixing of the H2S in the water and dissolving any remaining H2S gas bubbles in the water.

In one embodiment, said step (S3) 105 of dissolving CO2 and/or H2S gas in the water comprises conducting the CO2 and/or H2S gas via an injection pipe having an open end extending down into said injection well at a depth, h1≥0, that is selected such that the hydraulic pressure of the water in the injection well at the open end of the injection pipe is less than the CO2 and/or H2S gas pressure in the injection pipe. Preferably, the hydraulic pressure is slightly less that the CO2 and/or H2S gas pressure in the pipeline at this open end, firstly to ensure that the CO2 and/or H2S gas can enter the water in the injection well, and secondly, that after having entered the water at depth h1≥0 and having travelled some distance downwardly with the water stream, that the hydraulic pressure at that larger depth, h1+h2 (i.e. after the CO2 and/or H2S has travelled the distance h2 downwardly), is larger than the pressure of the dissolved CO2 and/or H2S in the water. This injection pipe may e.g. be a pipe that extends from a gas separation station where CO2 and/or H2S gas is separated from geothermal gas and subsequently conducted to the injection well via a pipeline.

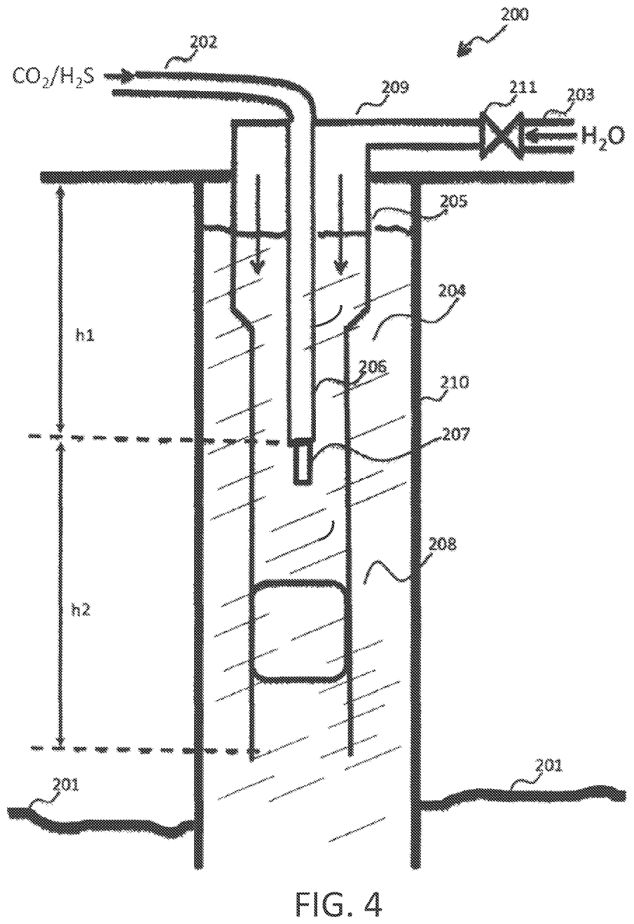

FIG. 4 depicts graphically an embodiment of a system 200 according to the present invention for storing carbon dioxide CO2 in a geological reservoir 201. The system comprises a CO2 gas pipeline 202, a wellhead 209, water inlet 203, a gas injection pipe 206, a sparger 207, a mixer 208 and an outer water injection pipe 204. The CO2 is conducted to the wellhead 209 under high pressure and into the injection well 210 via the gas injection pipe 206 having an open end at a depth h1 2′ 0, but the injection pipe 206 is surrounded by an outer water injection pipe 204 having an open end positioned at depth h1+h2. In this embodiment, the amount of water (liters/second) pumped into the injection well 210 is controlled via a valve 211, where the water is pumped into the space between the injection pipe 206 and the outer water pipe 205.

The depth at the open of the injection pipe at depth h1≥0 is selected such that the hydraulic pressure of the water at this depth is slightly less than the CO2 gas pressure in the injection pipe. This is to ensure that the CO2 gas can go into the water. Further downwards of the injection of the CO2 gas into the water, i.e. at depth h1+Δh with Δh<<h1 the hydraulic pressure of the water is larger than the pressure of the dissolved CO2. This is to ensure that the pressure of the dissolved CO2 will be less than the hydraulic pressure so that it stays dissolved in the water.

The water flow velocity into the space between the injection pipe 206 and the outer pipe 204 is selected such that the flow velocity of the water as indicated by the arrows is larger than the upwardly velocity of the CO2 gas bubbles due to the buoyant force on the CO2 gas at the open end of the injection pipe. Hence, as CO2 bubbles move downward, the hydraulic pressure increases, CO2 dissolves into the water and bubbles become smaller resulting in reduced upward velocity of the bubbles. A preferred condition is when the bubbles are small since then the upward travelling velocity of the bubbles is small and also the total surface area is larger resulting in enhanced dissolution rate.

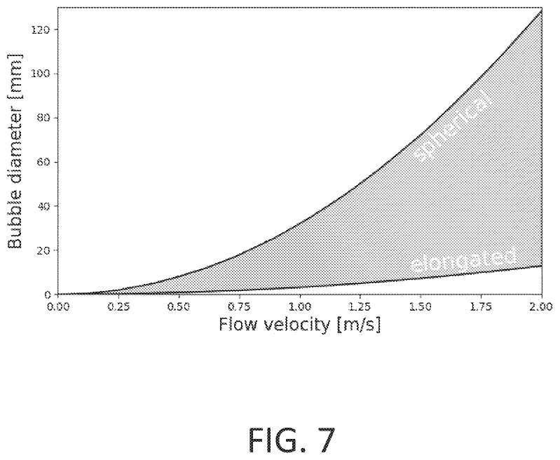

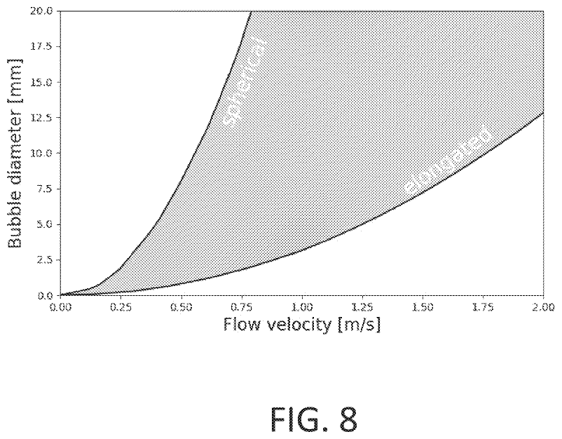

One way to analyze the water flow velocity needed down the pipe to avoid spherical gas bubbles from rising up the injection pipe is to calculate when the buoyancy of the gas bubbles, with the density of the carbon dioxide bubbles, at the relevant pressure and temperature (in the form of perfect sphere) is equal to the drag force at the downward flow velocity of the water. At these conditions the spherical gas bubbles would be stationary. If the flow velocity would be less the bubbles would travel upwards and if the flow velocity would be higher the bubbles would travel downwards with the water flow. The results of the calculations are shown in FIGS. 7 and 8. The horizontal axis shows the downward flow velocity of the water in m/s and the vertical axis shows the diameter of the bubble in mm. As the gas bubbles are not solid spheres they can deform and will become oblate spheroids in a flowing medium. This applies especially for the larger gas bubbles as the surface tension will keep the smaller ones more spherical. Methods or systems working with relatively small bubbles, e.g. below 6 mm in diameter, will according to the present invention be capable of operation at relatively low flow velocities, e.g. below 0.4 m/s, whereas methods or systems working with relatively large bubbles, e.g. above 20 mm in diameter, will according to the present invention be capable of operation at relatively high flow velocities, e.g. above 0.8 m/s.

Referring back to FIG. 4, the sparger 207 is placed at the open end of the injection pipe 206 for maximizing the interfacial area between the CO2 gas and the water. By doing so, the CO2 gas bubbles will be equally distributed within the water, and further, the average diameter of the bubbles will be reduced causing said maximization of the interfacial area between the CO2 gas and the water.

Below the sparger is the mixer 208, the role of which is to mix the dissolved CO2 with the water so as to obtain a uniform mixing and dissolve any remaining CO2 gas bubbles in the water. Accordingly, more turbulence will be created, which will enhance the dissolution of CO2 gas further. Also, large CO2 gas bubbles will be split into smaller gas bubbles, which will also enhance the dissolution rate of the CO2.

In one embodiment, the depth h1 of the water column within the outer pipe is around 250 m meaning that the hydraulic pressure becomes 24.5bars. This means that the pressure of the CO2 gas is slightly larger than 24.5bars. As soon as it leaves the open end of the injection pipe 206 and passes the sparger 207 it will be dispersed as small bubbles and thereafter dissolved in the water. Due to the constant water flow into the space between the injection pipe and the outer pipe 204 a vertical downwardly pointing velocity is created causing the dissolved CO2 to travel towards the open end of the injection pipe at said depth of h1+h2. This depth is preferably selected such that the pH value of the dissolved CO2 will be around 3.2, but the pH value decreases with increasing CO2 pressure. This corresponds when h1+h2~520 m. It is at this depth that the dissolved CO2 leaves the system 200 and the sequestration of the CO2 in basaltic rocks starts. The lower the pH value is, the higher will the dissolution rate be within the basaltic rock.

An additional advantage of the present invention is its cost relative to conventional technologies. The overall “on site cost” of this gas mixture capture, transport and storage at the CarbFix2 Hellisheidi site is US $24.8/ton of gas mixture CO2/H2S. This is significantly lower than the price (USD 35 to USD 143 pr. ton CO2) that has been reported by others (Ref 12: Global CCS Institute; Ref 13: Rubin et al; Ref 14: HU and Zhai, Ref 16: Sigfusson et al; Ref 17: Gunnarsson et al). This study has demonstrated the efficiency and cost advantages of the capture and storage of mixed, dissolved gas streams at the deep geological sites.

While the present invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

Referring to the accompanying figures the present invention in particular relates to a method of abating carbon dioxide (CO2) and/or hydrogen sulfide (H2S), comprising the steps of;
pumping or transferring water from a water source into an outer pipe (205) of an injection well (210) thereby creating a pressurized water stream in said outer pipe (205),
pumping a CO2 and/or H2S rich gas into a gas injection pipe (206) of an injection well
(210) thereby creating a CO2 and/or H2S rich gas stream comprising pressurized CO2, and/or pressurized %, in said injection pipe (206)
dissolving substantially all of said pressurized CO2 and/or H2S gas of said CO2 and/or H2S rich gas stream in said pressurized water stream by merging said pressurized water stream and said CO2 and/or H2S rich gas stream at a depth, h1≥0, where the hydraulic pressure of said water in said outer pipe (205), p(W), is lower than the pressure of said CO2 and/or H2S, p(C) and/or p(H), in said injection pipe (206)
keeping said dissolved CO2 and/or H2S in solution in said water stream by transferring said water stream from said depth h1≥0 to a depth h1+h2, where (h1+h2)>h1, at a downward flow velocity, v(W), which at h1+h2 is higher than the upward flow velocity of said CO2 and/or H2S gas, v(C) and/or v(H), resulting from the buoyant force on bubbles of CO2 and/or H2S gas in said water stream at said depth h1+h2
injecting said pressurized water stream comprising dissolved CO2 and/or H2S into a geological reservoir comprising reactive rocks at h1+h2 or at a depth>(h1+h2).

In a particular preferred embodiment of a method according to the invention the geological reservoir is a geothermal reservoir.

In a particular preferred embodiment of a method according to the invention the interfacial area between the CO2 and/or H2S to be dissolved in said water stream is increased by fitting said injection pipe (206) with a means for sparging (207) at the merging point at depth h1.

In a further particularly preferred embodiment of a method according to the invention said depth h1 is about 250-750 m, such as 250-600 m or 400-750 m, such as 300-600 m or 500-750 m.

In a further particularly preferred embodiment of a method according to the invention said downward flow velocity of said water, v(W), is 0.5-1 m/s, such as 0.6-0.9 m/s, e.g. 0.65-0.85
m/s, such as e.g. 0.7 m/s.

In a further particularly preferred embodiment of a method according to the invention said injection pipe (206) extends downwardly inside said outer pipe (205), comprising said pressurized water stream, and has an open end at said depth h1≥0.

In a yet further particularly preferred embodiment of a method according to the invention said outer pipe (205), comprising said pressurized water stream, has an open end at said depth h1+h2.

In a yet further particularly preferred embodiment of a method according to the invention the pressure of CO2, p(CO2), at the merging point at depth h1≥0 is between about 15-40 bar, such as 17-38 bar, e.g. 20-36 bar, preferably between about 22-34 bar, more preferably between about 24-32 bar, most preferably about 24.5 bar.

In a yet further particularly preferred embodiment of a method according to the invention the pressure of H2S, (pH), at the merging point at depth h1≥0 is between about 3-9 bar, such as between 4-8 bar, preferably between about 5-7 bar, more preferably between about 5.5-6.5 bar, such as between 5.6 and 6.4, e.g. 5.7 and 6.3 bar and most preferably about 6 bar.

In a yet further particularly preferred embodiment of a method according to the invention the resulting pH value of said pressurized water stream containing said dissolved CO2 and or H2S is between about 1 and 5, such as between about 2 and 4, preferably between about 2.5 and 3.5, such as between about 2.6 and 3.4, more preferably about between 2.7 and 3.3, such as 3.2.

In a yet further particularly preferred embodiment of a method according to the invention, the method further comprises the steps of:
dissolving a tracer substance, in a predetermined molar ratio compared to said dissolved CO2 and/or H2S, in said pressurized water stream at said depth hi>0 in said outer pipe(205) in said injection well (210/612),
establishing a monitoring well (610) being interlinked to said outer pipe (205) of said injection well (210/612) via a flow path (614), whereby at least a part of said pressurized water mixed with said dissolved CO2 and/or H2S and said tracer substance flows from said outer pipe (205) of said injection well (210/612) to said monitoring well (610) via said flow path (614),
measuring the concentration of CO2 and/or H2S and tracer substance at said monitoring well (610) and establishing based thereon the molar ratio between CO2 and/or H2S and tracer substance at said monitoring well (610), and
determining an abatement indicator indicating the degree of CO2 and/or H2S abatement based on comparing the molar ratio between CO2 and/or H2S and the tracer substance at said monitoring well (610) with said predetermined molar ratio in said pressurized water stream at said depth hi in said outer pipe (205) in said injection well (210/612).

Referring to the accompanying figures the present invention furthermore in particular relates to a system for abating carbon dioxide (CO2) and/or hydrogen sulfide (H2S), comprising:
an injection well (210)
an outer pipe (205) extending downwardly inside said injection well (210)
an injection pipe (206) extending downwardly inside said injection well (210)
means for pumping or transferring water from a water source into said outer pipe (205) thereby creating a pressurized water stream in said outer pipe (205),
means for pumping a CO2 and/or H2S rich gas into said injection pipe (206) thereby creating a CO2 and/or H2S rich gas stream comprising pressurized CO2, and/or pressurized H2, in said injection pipe (206)
means for merging said pressurized water stream and said CO2 and/or H2S rich gas stream at a depth, h1≥0, where the hydraulic pressure of said water in said outer pipe (205), p(W), is lower than the pressure of said CO2 and/or H2S, p(C) and/or p(H), in said injection pipe (206)
means for transferring said water stream from said depth h1≥0 to a depth h1+h2, where (h1+h2)>h1, at a downward flow velocity, v(W), which at h1+h2 is higher than the upward flow velocity of said CO2 and/or H2S gas, v(C) and/or v(H), resulting from the buoyant force on bubbles of CO2 and/or H2S gas in said water stream at said depth h1+h2
means for keeping the resulting pH value of said pressurized water stream containing said dissolved CO2 and/or H2S between about 2 and 4, preferably between about 2.5 and 3.5, more preferably about 3.2
means for injecting said pressurized water stream comprising dissolved CO2 and/or H2S into a geological reservoir comprising reactive rocks at h1+h2 or at a depth>(h1+h2).

In a particular preferred embodiment of a system according to the present invention the system further comprises means for sparging (207) fitted onto said injection pipe (206) at the merging point at depth h1≥0.

In a further particularly preferred embodiment of a system according to the invention said depth h1≥0 is about 250-750 m, such as 250-600 m or 400-750 m, such as 300-600 m or 500-750 m.

In a further particularly preferred embodiment of a system according to the invention said means for transferring said water stream from said depth hi to a depth h1+h2, where (h1+h2)>h1, is capable of providing a downward flow velocity of said water, v(W), which is 0.5-1 m/s, such as 0.6-0.9 m/s, e.g. 0.65-0.85 m/s, such as e.g. 0.7 m/s.

In a further particularly preferred embodiment of a system according to the present invention said injection pipe (206) extends down into said outer pipe (205) and has an open end at said depth h1≥0.

In a yet further particularly preferred embodiment of a system according to the present invention said outer pipe (205) has an open end at said depth h1+h2.

In a yet further particularly preferred embodiment of a system according to the present invention, the system further comprises:
means for dissolving a tracer substance, in a predetermined molar ratio compared to said dissolved CO2 and/or H2S, in said pressurized water stream at said depth h1≥0 in said outer pipe (205) in said injection well (210/612),
a monitoring well (610)
a flow path (614), whereby at least a part of said pressurized water mixed with said dissolved CO2 and/or H2S and said tracer substance flows from said outer pipe (205) of said injection well (210/612) to said monitoring well (610),
means for measuring the concentration of CO2 and/or H2S and tracer substance at said monitoring well (610) and establishing based thereon the molar ratio between CO2 and/or H2S and tracer substance at said monitoring well (610), and
means for determining an abatement indicator indicating the degree of CO2 and/or H2S abatement based on comparing the molar ratio between CO2 and/or H2S and the tracer substance at said monitoring well (610) with said predetermined molar ratio in said pressurized water stream at said depth hi in said outer pipe (205) in said injection well (210/612).

The methods and systems according to the present invention may be further illustrated by way of the following examples.

### Example 1

0.07 kg/s of CO2 comes from the gas purification unit or a gas separation station of a geothermal power plant. The initial pressure of the gas is 30 bar. For the transportation of the gas to the injection well a pipe is selected with outer diameter (OD) 40 mm, resulting in a pressure drop of 1.45 bar. Including other pressure losses it is assumed that the pressure at the well head is 28 bar. For the injection a pipe with OD 32 mm is selected resulting in pressure drop of 0.41 bar, but due to gravity the pressure head at the merging point will increase by 1.1 bar and the pressure at the merging point will be 28.6 bar.

The injection pipe is a pipe with OD 75 mm and needs a volumetric flow rate of 1.94 kg/s of water to dissolve the gaseous carbon dioxide. The pressure drop under those conditions is 0.51 bar/100 m. Therefore, the water column in the injection pipe will be approximately 13 m above the water level in the well due to the pressure drop down to the merging point. It is not necessary to change the location of the merging point due to this increased pressure. However, the water column in the pipe will rise further by approximately 15 m due to pressure drop in the pipe below the merging point and therefore the merging point must be elevated accordingly. Thus, the water level will be approximately 28 m above the water level in the well. To have 25 bar pressure at the merging point it must be 255 m below the water level in the pipe or 227 m below the water level in the well.

Under those conditions the pressure drop in the merging can be up to 3.6 bar. The water downward flow velocity at the merging point will be approximately 0.95 m/s. The same procedure was applied with lower water flow rate at 1.73 kg/s resulting in downward flowing velocity at the merging point of 0.85 m/s. This lower flow rate, however, prevented an efficient downward movement of all gas bubbles resulting in untimely shutdown of the process. If the inner diameter of the water pipe is diminished at the merging point, a sufficient downward water flowing velocity can be achieved even at the reduced water flow rate of 1.73 kg/s ensuring full dissolution of the gas bubbles. Such a design will reduce the water demand of this gas abatement method.

### Example 2

In this example, the partial pressure of carbon dioxide is selected to be 25 bar downhole. This means saturation at 25 bar pressure or 36 g CO2 pr. kg water at 17° C. At this temperature and pressure the volume of carbon dioxide is approximately 20 times the volume of the equivalent mass of water at atmospheric pressure. For the water to be able to pull the gas downwardly, the volume of the gas should not exceed the volume of the water, preferably be much smaller. For the water to be able to bring the gas downward in the pipe, the water pressure at the gas release point (merging point) should preferably be near the saturation pressure of 25 bar. If however a sufficient volumetric water flow rate is maintained it is possible to have the pressure lower. Part of the gas will dissolve in the water and the remaining gas will form small bubbles and travel with the water down the pipe. As the depth increases the bubbles become smaller as the pressure increases and the gas continues to dissolve in the water until all the gas has been dissolved.

### Example 3

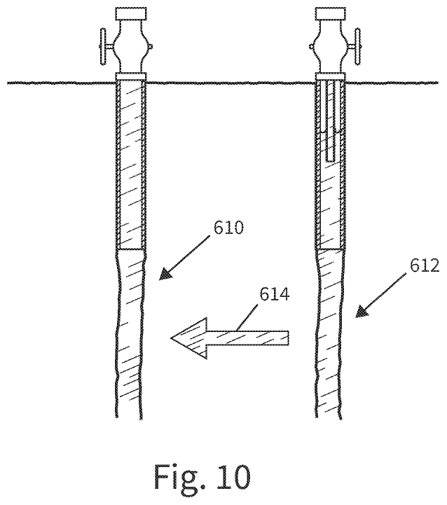

In this embodiment, shown in FIG. 10, a monitoring well 610 is interlinked to the injection well 612 via a flow path 614, which may e.g. be a fracture in the geological reservoir. The implementation of this monitoring well 610 is to estimate the mineralization capacity of the CO2. The step of estimating comprises using one or more tracer substances for tracing the CO2 gas, or the water, or the carbon. Thus, one or more types of tracers may be added via an appropriate tracer source for tracing one or more of these in a controllable way such that the molar ratio between the CO2 gas, or the water, or the carbon, and the tracer substance(s) is pre-determined, i.e. the molar ratio is prefixed. This means that only one tracer can be used for tracing e.g. only CO2, or only C, or only water, or a combination thereof. As an example, SF5CF3 tracer, SF6 tracer or Rhodamine tracer may be implemented to track the dilution between the injected fluid and the ambient water in the reservoir as well as to characterize the advective and dispersive transport of the CO2 saturated solution in the storage reservoir. C-14 tracer concentration injected with the CO2 can on the other hand change as a result of CCE-water-rock interaction and therefore allows for estimation the degree of mineralization for the injected CO2 in turns of mass balance calculations. A monitoring equipment may be provided (not shown here) for monitoring the molar ratio between the CO2 gas, or the water, or the carbon, and the tracer substance(s) in this monitoring well 610 as a consequence of injecting said dissolved CO2. As already mentioned, the monitoring well 610 is interlinked to the injection well 612 via said flow path such that at least a part of the injected water mixed with the dissolved CO2 and said tracer substance(s) flows to the monitoring well 610 via said flow path 614. By comparing the molar ratio at the monitoring well 610 and the injection well 612 an abatement indicator can be determined indicating the amount of CO2 sequestration via water-rock reactions. Accordingly, if the tracer used is SF5CF3 tracer and the molar ratio between [SF5CF3]/[CO2] is 1 at the injection well 612 but 2 at the monitoring well 610, this would clearly indicate that half of the CO2 has been subjected to chemical reactions with the rock via said water-rock reactions.

Such a monitoring well 610 may just as well be implemented in relation to the embodiment shown in FIG. 4.

### Example 4

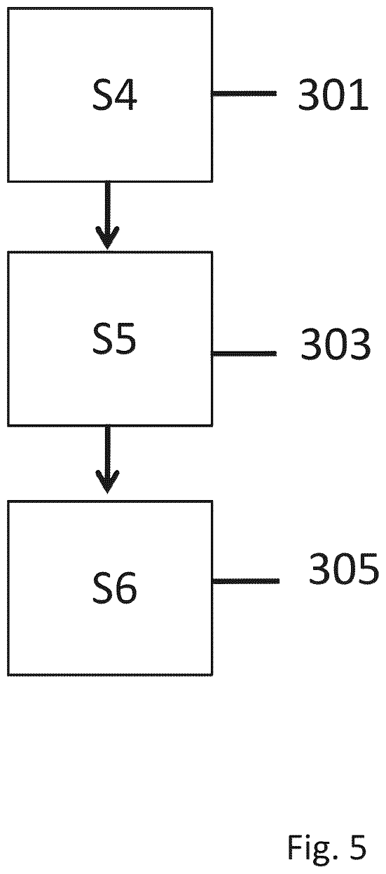

FIG. 5 shows one embodiment of a method according to the present invention of abating hydrogen sulfide in a geothermal reservoir, where the mineralization capacity of the H2S is estimated. This method may either occur prior to said method steps in FIG. 1 or be implemented as a monitoring method performed at some later time.

In step (S4) 301, a tracer substance such as KI is dissolved in addition to the dissolved H2S in a controllable way so that the molar ratio between FES and the tracer substance will be pre-determined.

In step (S5) 303, a monitoring is performed, in response to injecting the dissolved H2S and the dissolved tracer substance into the injection well, of the molar ratio between the H2S and the tracer substance in a monitoring well. This monitoring is a well that is interlinked to the injection well via a flow path such as cracks or fracture in the rock such that at least a part of the injected water mixed with said dissolved H2S as said tracer substance flows to the monitoring well via this flow path. This monitoring includes then measuring the concentration of the H2S and the tracer substance and based thereon the molar ratio between the H2S and the tracer substance at the monitoring well.

In step (S6) 305, an abatement indicator is determined indicating the amount of H2S abatement via water-rock reactions based on comparing the molar ratio between the H2S and the tracer substance at the monitoring well with the corresponding molar ratio at the injection well. For example if the H2S/tracer molar ratio that goes into the injection well is 1.0 but 0.5 at the monitoring well, this would indicate that half of the dissolved H2S becomes mineralized in the geothermal reservoir via water-rock reactions. However, to improve the method even further, it would be preferred to perform a correction taking into account oxidation of H2S to other sulfur species, which could cause uncertainty.

### Example 5

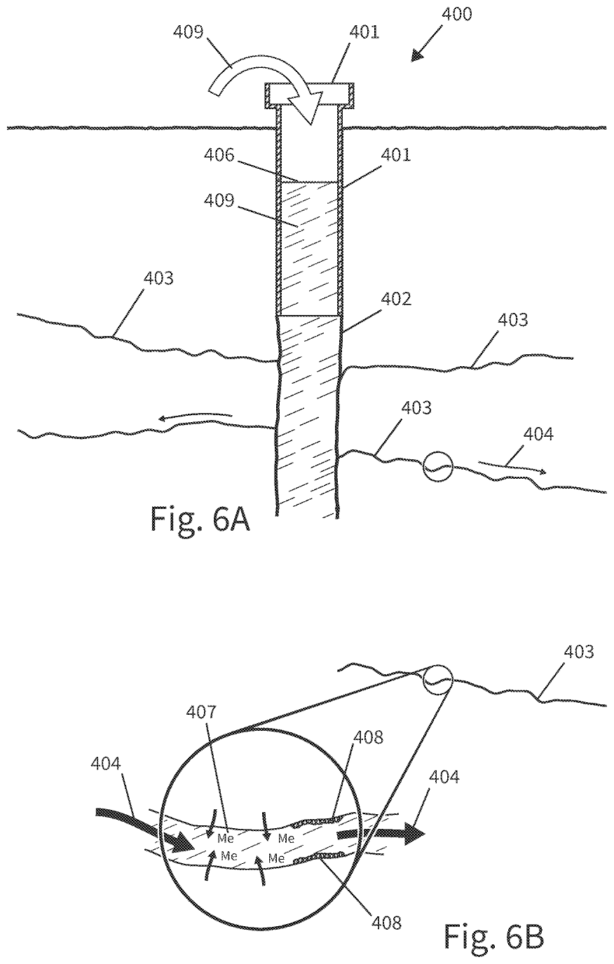

FIG. 6A depicts schematically the method in FIG. 5 showing an injection well 400 where water 409 is continuously being pumped into the well 400. The total depth of such a well can be several kilometers. As shown here, the well is partly filled with water, where the water surface 406 is close to the closing cap of the casing 401 of the injection well. Due to continuous pumping of water, a water stream is formed in the well extending downward into the hole, where some of the water will flow into the geothermal reservoir 403 in a direction as indicated by the arrow 404. As depicted here, the injection well includes a casing 401 such as a steel pipe which seals the well (e.g. seals it from fresh groundwater above the geothermal reservoir). The height of such a casing 401 can vary from a few hundred meters up to more than 1000 meters. As shown here, the remaining part of the injection well is in the rock 402. The water-rock reactions that occur in the geothermal reservoir is indicated in the expanded view in FIG. 6B showing a flow path of the dissolved H2S in the rock, where the dissolved H2S reacts chemically with metal ions (Me) 407 in rock and forms Me sulfides 408. If e.g. the Me is Fe the Me sulfide will be Fe-sulfide.

The temperature of the water 409 being pumped into the well will, if the water source is a geothermal well, typically be around 100° C., but preferably it is colder since then less water would be needed to dissolve the H2S than with hot water. This, however, depends on the water source, i.e. whether a fresh water source is being used (cold water) instead of geothermal water source.

### Example 6

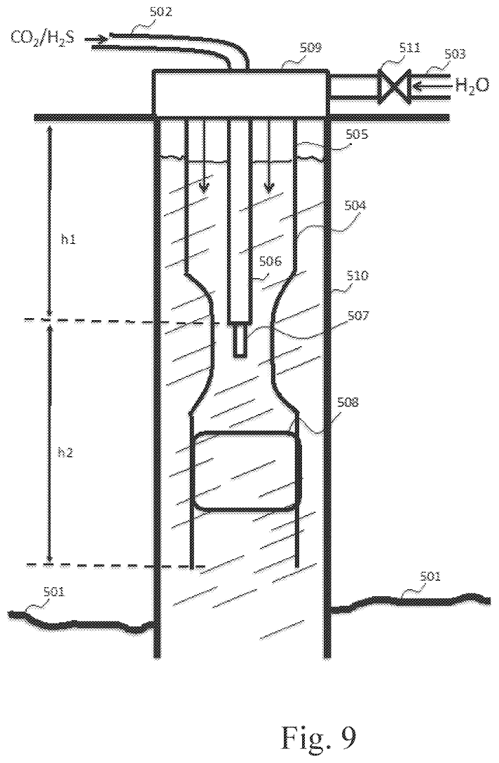

FIG. 9 depicts graphically an embodiment of a system according to the present invention for abating hydrogen sulfide (H2S) in a geothermal reservoir 501. The system comprises a H2S gas pipeline 502, a wellhead 509, water inlet 503, an injection pipe 506, a sparger 507, a mixer 508 and an outer pipe 504. The H2S is conducted to the wellhead 509 under high pressure and into the injection well 510 via the injection pipe 506 having an open end at a depth h1 2′ 0, but the injection pipe 506 is surrounded by an outer pipe 504 having an open end positioned at depth h1+h2. In this embodiment, the volumetric flow rate of water (liters/second) into the injection well 510 is controlled via a valve 511, where the water is pumped into the space between the injection pipe 506 and the outer pipe 505.

The depth at the open of the injection pipe at depth hi is selected such that the hydraulic pressure of the water at this depth is slightly less than the H2S gas pressure in the injection pipe. This is to ensure that the H2S gas can go into the water. Below the site of the injection of the H2S gas at depth h1+Δh with Δh<<h1 the hydraulic pressure of the water is larger than the internal pressure of the dissolved H2S.

The water flow into the space between the injection pipe 506 and the outer pipe 504 is selected such that the volumetric flow rate and hence velocity of the water (as indicated by the arrows) is larger than the upwardly pointing velocity of the H2S gas due to the buoyant force on the H2S gas at the open end of the injection pipe. Hence, as H2S bubbles move downward, the hydraulic pressure increases and bubbles become smaller resulting in reduced upward pointing velocity of the bubbles. A preferred condition is when the bubbles are small since then the upward travelling velocity of the bubbles is small and also the total surface area is larger resulting in enhanced dissolution rate.

In this embodiment, the sparger 507 is placed at the open end of the injection pipe 506 for maximizing the interfacial area between the H2S gas and the water. By doing so, the H2S gas bubbles will be equally distributed within the water, and further, the average diameter of the bubbles will be reduced causing said maximization of the interfacial area between the H2S gas and the water.

Below the sparger is the mixer 508. The role of the mixer is to mix the dissolved H2S with the water so as to obtain a uniform mixing of the H2S gas in the water and dissolving any remaining H2S gas bubbles in the water. Accordingly, more turbulence will be created, which will enhance the dissolution rate of H2S gas further. Also, large H2S gas bubbles will be split into smaller gas bubbles, which will also enhance the dissolution rate of the H2S.

### Example 7

FIG. 10 depicts graphically another embodiment of a system according to the present invention for abating inter alia hydrogen sulfide (H2S) in a geothermal reservoir. In this embodiment, a monitoring well 610 is interlinked to the injection well 612 via a flow path 614, which may e.g. be a fracture in the geothermal reservoir. The implementation of this monitoring well 610 is to estimate the mineralization capacity of the H2S as discussed previously in relation to FIG. 5.

### Example 8

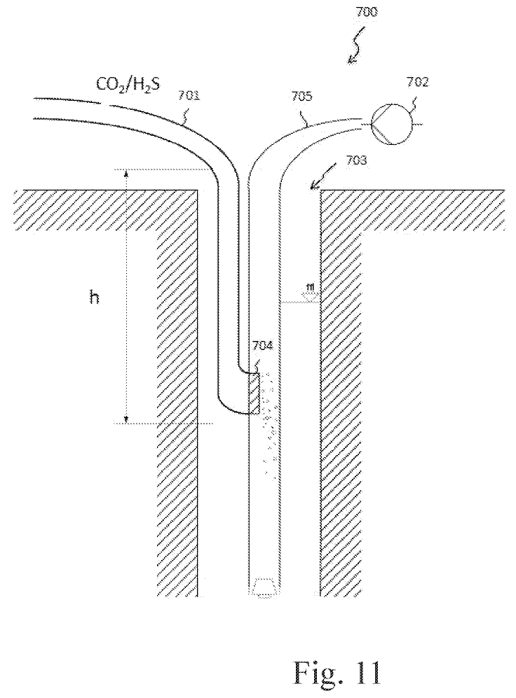

FIG. 11 depicts graphically yet another embodiment of a system 700 according to the present invention for abating hydrogen sulfide (H2S) in a geothermal reservoir. In this embodiment the H2S is transferred down to the injection well 703 in a separate pipe 701 outside the water injection pipe 705. Since the pipe is fastened at the wellhead (not shown here) the depth of the merging point cannot be changed if conditions change such as changed forward water flow “ffl” (designated by an arrow and corresponding initials in FIG. 11). It is thus preferred to implement a pressure control valve 702 at the end of the injection pipe 705 to maintain a constant pressure at the merging point 704. The advantage of this solution is lower pressure drop in the injection pipe and therefore higher water flow rate can be maintained which makes it easier to pull the gas bubbles down the pipe.

### Example 9

A significant part of the security risk associated with geologic carbon storage occurs because gaseous CO2 is prone to escape back to the surface and leak into the atmosphere or into overlying fresh-water aquifers. This is particularly problematic when the storage is attempted in porous geological formations.

The present set of experiments were performed at the geothermal plant in Hellisheidi, Iceland. The rocks at the Hellisheidi injection site are of ultramafic to basaltic composition and highly permeable in both lateral and vertical directions (300 and 1700×10⁻¹⁵m², respectively) and an estimated 8.5% porosity.

Using a device as the one depicted in FIG. 4 CO2 and H2O was injected at a target mass rate of 70 and 1940 g s 1, respectively. The CO2 and H2O was released at a depth of 330-360 m. At this depth, CO2 was released via a sparger in the form of small gas bobbles into the flowing H2O. The CO2/H2O mixture was carried from the sparger via a mixing pipe extending down to 540 m where it was released to the subsurface rocks. Approximately half the way (approximately at 420 m) a static mixer was located to aid CO2 dissolution. Over a period of 3 months approximately 175 t of CO2 together with approximately 5000 t H2O were injected into the subsurface at the site.

Verification of the complete dissolution of CO2 during its injection was performed by digital downhole camera (showing no CO2 bubbles and by high-pressure well water sampling using a custom made bailer.

Images show the well fluid to be void of gas bubbles consistent with the complete dissolution of CO2 1.5 m above the fluid outlet at 540 m.

12 well water samples were analyzed for total dissolved inorganic carbon and 6 of the 12 were measured for in-situ pH. In each case the dissolved inorganic carbon concentration of the sample fluid was on average within 5% of the 0.82±2% mol/kg concentration based on measured CO2 and H2O mass flow rates into the well and the fluid pH was 3.89±0.1 confirming the complete dissolution of the CO2 during its injection.

Thus if injected into the subsurface as a dissolved phase, CO2 is far less likely to escape back to the atmosphere due to its lack of bubble-formation or buoyancy (Ref 15: Gilfillan et al, 2009).

### Example 10

A further experimental injection of CO2/H2S was carried out with the following parameters:

| | Water | CO₂ | H₂S |
|---|---|---|---|
| Temperature (° C.) | 23 | 18 | 18 |
| Pressure at mixing | 1.4 | 10.9 | 3.6 |
| point (bar-a) | | | |
| Mass flow rate (g/s)_{—} | 1.4 | 27.4 | 7.1 |
| Water downward | 1.04 | | |
| flow velocity above | | | |
| merging poing (m/s) | | | |
| Water downward | 0.65 | | |
| flow velocity below | | | |
| merging point (m/s) | | | |

In this example, the partial pressure of carbon dioxide and hydrogen sulphide was selected to be 18 bar and 6 bar downhole.

The pH value of the water with the dissolved CO2 will decrease with increasing CO2 pressure as this increases the CO2 content of the water. In one experiment the depth was selected such that the pH value was around 3.2. This corresponded to a depth of 520 m. As is clear from the table above, the downward velocity of the water in this example was app. 0.7 m/s. Changing the downward velocity of the water to app. 0.3 m/s resulted in failure.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A method for storing carbon dioxide (CO₂) in a geological reservoir, comprising:
transferring water from a water source to an injection well,
dissolving CO₂ in the water by merging a CO₂ rich gas stream with the water at a depth h1=0 under conditions where the hydraulic pressure of the water is lower than the partial pressure of the CO₂ in the CO₂ rich gas stream, and
ensuring, when transferring the water with the CO₂ downwardly, that the pressure of the CO₂ is less than the hydraulic pressure of the water such that the CO₂ stays dissolved in the water, and
injecting the water comprising the dissolved CO₂ into the geological reservoir.

2. The method according to claim 1, further comprising keeping the resulting pH value of said pressurized water stream containing said dissolved CO₂ between about 2 and 4.

3. The method according to claim 1, wherein the step of transferring the water from the water source to the injection well includes pumping the water and increasing the pressure of the water to form pressurized water.

4. The method according to claim 3, wherein the step of pumping the water from the water source to the injection well is performed via a pipeline, where the pressure of the water in the pipeline is increased such that the pressure may be adjusted to the pressure of the CO₂ to be dissolved.

5. The method according to claim 3, wherein the pressure of the water is around 6 bars or lower than the partial pressure of the CO₂.

6. The method according to claim 3, wherein the step of injecting the water comprising the dissolved CO₂ into the geological reservoir is performed via an injection pipe having an open end extending into the injection well at h1=0, where at depth h2>0, which is reached when the water with the CO₂ flows downward, the hydraulic pressure of the water in the injection well is larger than the pressure of the dissolved CO₂ in the water.

7. The method according to claim 1, wherein the water with the dissolved CO₂ is transferred downwardly at a velocity resulting in that the hydraulic pressure of the water is larger than the partial pressure of the CO₂ when it was merged with the water.

8. The method according to claim 7, wherein the CO₂ is conducted via an injection pipe having an open end at said h1=0 and where the step of dissolving the CO₂ in the water takes place at the open end of the injection pipe.

9. The method according to claim 1, wherein the water is transferred downwardly at a minimum water velocity between 0.4 m/s and 1.4 m/s when the bubbles are below 6 mm in diameter.

10. The method according to claim 1, wherein the water is transferred downwardly at a minimum water velocity above 0.8 m/s when the bubbles are above 20 mm in diameter.

11. The method according to claim 1, comprising determining a velocity of the water by calculating when the buoyancy of the CO₂ bubbles, with the density of the CO₂ bubbles, at the relevant pressure and temperature is equal to the drag force at the downward flow velocity of the water.

12. A system for abating CO₂, comprising:
means for pumping water from a water source into an injection well,
means for pumping CO₂ into an injection well
means for dissolving the CO₂ in the water by merging a CO₂ rich gas stream at a depth, h1=0, in the injection well where the hydraulic pressure of the water is lower than the pressure of the CO₂,
means for transferring said water stream from said depth h1=0 to a greater depth h2>0 at a downward flow velocity, which is higher than the upward flow velocity of the bubbles of said CO₂, resulting from the buoyant force on said bubbles of CO₂ in said water,
means for injecting the water comprising said dissolved CO₂ into a geological reservoir.

13. The system according to claim 12, wherein the means for dissolving CO₂ in the water comprises an injection pipe for conducting high pressurized CO₂ into the injection well, the injection pipe having an open end extending down into said injection well at the depth h1=0, and pump means enabling a downward flow velocity of the water higher than the upward flow velocity of bubbles of said CO₂ at depths larger than h1, thereby ensuring that the water is transferred to depths larger than h1 without the CO₂ escaping the water.

14. The system according to claim 13, comprising an outer pipe surrounding said injection pipe having an open end extending down into said injection well at a further depth h2>0, said means for pumping being a water pump that pumps the water into the space between the outer pipe and the injection pipe.

15. The system according to claim 13, comprising
a sparger mounted at said open end of the injection pipe, the sparger being adapted to maximize an interfacial area between the CO₂ and the water, or
a mixer mounted within said outer pipe between said open end of the injection pipe and said open end of the outer pipe adapted for mixing the CO₂ with the water so as to obtain a uniform mixing of the CO₂ in the water and dissolving any remaining bubbles of CO₂ in the water, or
a sparger mounted at said open end of the injection pipe adapted to maximize the interfacial area between the CO₂ and the water and a mixer mounted within said outer pipe between said sparger and said open end of the outer pipe adapted for mixing the CO₂ with the water so as to obtain a uniform mixing of the CO₂ in the water and dissolving any remaining bubbles of CO₂ in the water.
